(19) United States
(12) Patent Application Publication
(10) Pub. No.: US 2002/0141203 A1
(43) Pub. Date: Oct. 3, 2002

(54) Elongate tube with extended rib for decorative light assembly

(76) Inventors: Whiter Shieh, Taipei (TW); S.T. Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/824,027

(22) Filed: Apr. 3, 2001

(51) Int. Cl. F21V 7/04

(52) U.S. Cl. 362/568; 362/567; 362/122; 362/123

(57) ABSTRACT

An elongate tube with at least one extended rib for a decorative light assembly is disclosed. The extended rib is extended in a direction parallel to a longitudinal axis of the elongate tube. One end of the elongate tube is supported on a top end of a central post, and the other end is spirally suspended around the central post. A number of ropes extend at a predetermined angle with respect to the central post and angularly spaced from each other about the central post, winding on the elongate tube thereby retaining the tube in a three-dimensional spiral shape. The elongate tube is further formed with a plurality of concave sections thereon, so that the rope passing across the elongate tube is wound on the concave section to prevent the rope from sliding along the elongate tube. A plurality of light units are electrically connected in series and arranged inside the hollow inner tube of the elongate tube in a manner equally spaced from each other.

### BACKGROUND OF THE INVENTION

1. Field of the Invention

The present invention generally relates to a decorative light assembly, and in particular to an elongate tube with at least one extended rib formed thereon for the decorative light assembly.

2. Description of the Prior Art

Decorative light strings are widely used in holidays and festivals, especially in Christmas. Conventionally, the decorative light string is arranged on a tree directly and randomly. For more versatile decorating purposes, various decorative light assemblies are developed in prior art. Spiral decorative light tree is one of the most popular decorative light products available in the market.

For example, a prior art spiral decorative light tree is shown in FIG. 1, which comprises an elongate tube 10, a plurality of ropes 20, an upright central post 30, and a stand 40. The elongate tube 10 is generally made of soft and transparent material with a hollow inner tube formed therein. A plug 11 is connected to the elongate tube 10 for supplying electric power thereto.

The light units may be constructed by small bulbs or LED lamps electrically connected in series to form a light string, and one of the light units may be a known flashing control bulb for controlling the flashing effects of the light string. A star-shape section 12 is formed on a first end of the elongate tube 10 and a free second end of the elongate tube 10 coils sequentially to form a spiral shape.

The central post 30 is used to support the elongate tube 10, and the bottom end of the central post 30 may be mounted on the stand 40. A supporting ring may be attached to a section near the top end of the central post 30 for the elongate tube 10 being supported thereon.

When spreading the elongate tube 10 to arrange on the central post 30, the first end of the elongate tube 10 is supported on the central post 30 and the free second end of which is spirally suspended around the central post 30.

The ropes 20 extend at a predetermined angle with respect to the central post 30 and angularly spaced from each other about the central post 30, binding on the elongate tube 10, thereby retaining the elongate tube 10 in a three-dimensional spiral shape.

A plurality of light units 13 are electrically connected in series and arranged inside the hollow inner tube of the elongate tube 10 in a manner equally spaced from each other, as shown in FIG. 2.

However, it is found that the decorative light tree is difficult to be kept in a spiral shape because that the elongate tube is normally made of soft material. Further, the ropes are easily to be slid along the elongate tube, causing a deformation to the spiral decorative light tree.

Thus, it is desired to have an improved elongate tube for the spiral decorative light assembly for overcoming the problems discussed above.

### SUMMARY OF THE INVENTION

Accordingly, a primary object of the present invention is to provide an elongate tube with at least one extended rib formed thereon, so as to prevent the elongate tube from deformation.

Another object of the present invention is to provide a spiral decorative light tree with an improved elongate tube for firmly retaining the decorative light tree in a three-dimensional spiral shape.

To achieve the above objects, in accordance with a preferred embodiment of the present invention, there is provided an elongate tube formed with at least one extended rib thereon. The rib is extended in a direction parallel to a longitudinal axis of the elongate tube. The rib is further formed with a plurality of concave sections thereon in a predetermined interval. One end of the elongate tube is supported on a top end of a central post, and the other end of which is spirally suspended around the central post. A number of ropes extend at a predetermined angle with respect to the central post and angularly spaced from each other about the central post. The ropes are wound on the concave sections of the elongate tube, thereby firmly retaining the elongate tube in a three-dimensional spiral shape.

### BRIEF DESCRIPTION OF THE DRAWINGS

The present invention will be apparent to those skilled in the art by reading the following description of preferred embodiments thereof, with reference to the accompanying drawings, in which:

FIG. 1 is a perspective view of a prior art spiral decorative light tree;

FIG. 2 is an enlarge exploded view showing a number of light units are arranged in the hollow inner tube of the elongate tube of the spiral decorative light tree of FIG. 1;

FIG. 3 is an enlarge exploded view of an elongate tube in accordance with a first embodiment of the present invention;

FIG. 4 is a cross sectional view of the elongate tube taken along line 1-1 of FIG. 3;

FIG. 5 is an enlarge exploded view showing a rope is wound on the elongate tube of FIG. 3;

FIG. 6 is an enlarge exploded view of an elongate tube in accordance with a second embodiment of the present invention;

FIG. 7 is a cross sectional view of the elongate tube taken along line 2-2 of FIG. 6;

FIG. 8 is an enlarge exploded view further showing a rope is wound on the elongate tube of FIG. 6;

FIG. 9 is an enlarge exploded view of an elongate tube in accordance with a third embodiment of the present invention;

FIG. 10 is a perspective view of a spiral decorative light tree constructed in accordance with the present invention; and

FIG. 11 is a perspective view of a spiral decorative light tree in a manner of pyramid configuration constructed in accordance with the present invention.

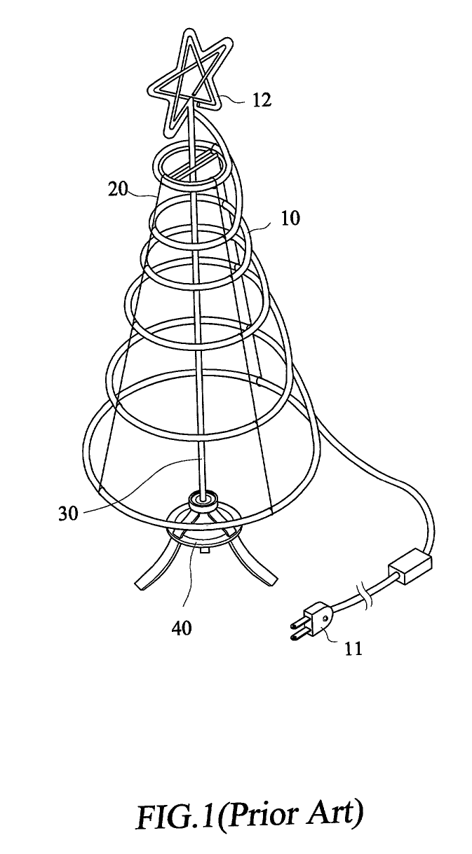

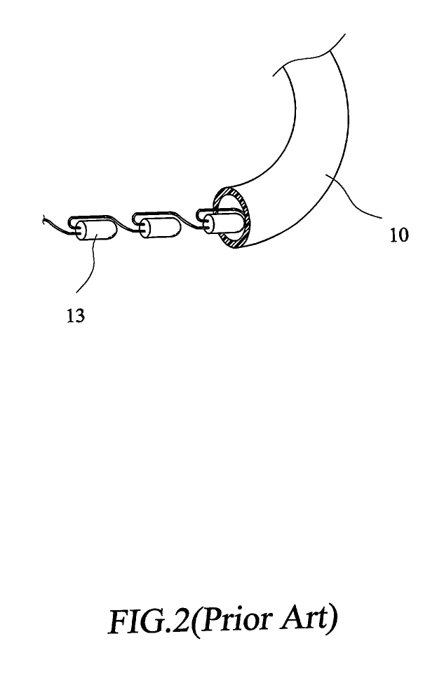

### DETAILED DESCRIPTION OF THE PREFERRED EMBODIMENTS

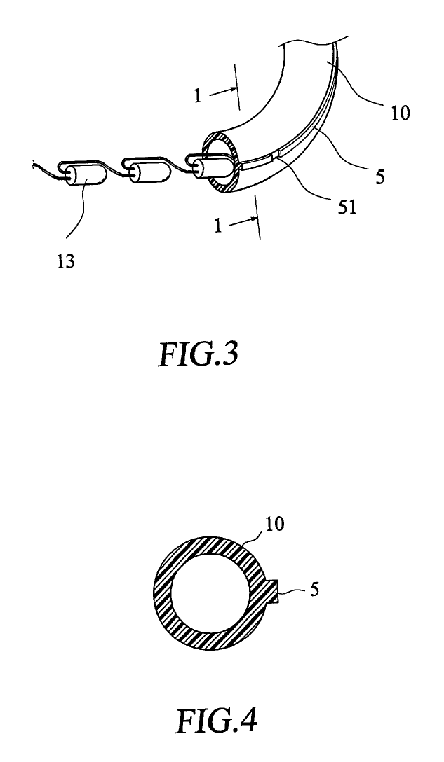

With reference to the drawings and in particular to FIGS. 3 through 5, an elongate tube for a decorative light assembly constructed in accordance to a first embodiment of the present invention is shown. For explanation, the same reference numbers used in the previous drawing will be used to refer to the same or like parts.

Similar to the prior art elongate tube of the spiral decorative light tree, the elongate tube 10 of the present invention has a hollow inner tube formed therein. A plurality of light units 13 may be electrically connected in series and arranged inside the hollow inner tube of the elongate tube 10 in a manner equally spaced from each other.

In accordance with the first embodiment of the present invention, the elongate tube 10 is formed with an extended rib 5 thereon. The extended rib 5 is extended in a direction parallel to the longitudinal axis of the elongate tube 10, and it is preferably formed on an outer fringe surface parallel to the longitudinal axis of the elongate tube 10, with reference to FIG. 4. The extended rib 5 is capable of preventing the elongate tube from deformation.

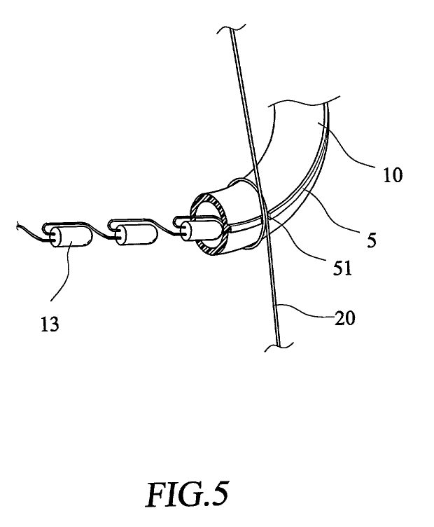

Besides, the elongate tube 10 is formed with a plurality of concave sections 51 in a predetermined interval thereon. When a rope 20 passes across the elongate tube 10, the rope 20 may be wound on the concave section 51 of the extended rib 5, so as to prevent the rope from randomly sliding along the elongate tube 10, as shown in FIG. 5, thereby retaining the elongate tube in a three-dimensional spiral shape.

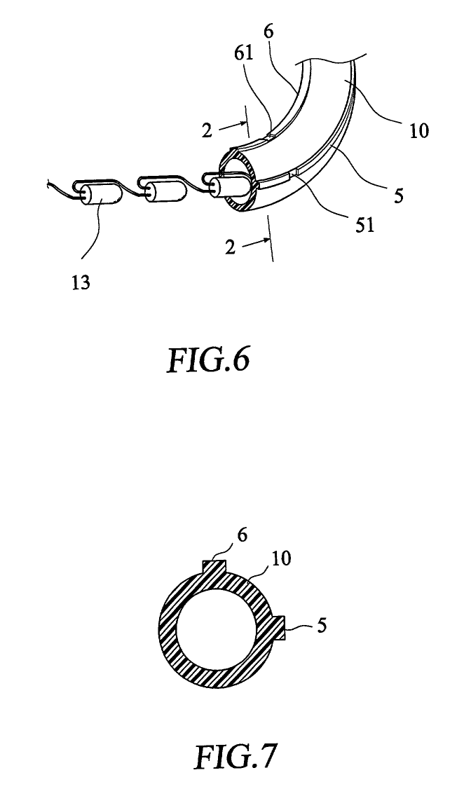

With reference to FIGS. 6 and 7, it is an enlarge exploded view of the elongate tube in accordance with a second embodiment of the present invention. The elongate tube of this embodiment is similar to that of the first embodiment described above, except that a second extended rib 6 is further formed on the top flange surface of the elongate tube 10. Similarly, the second extended rib 6 may be formed with at least one concave section 61 thereon.

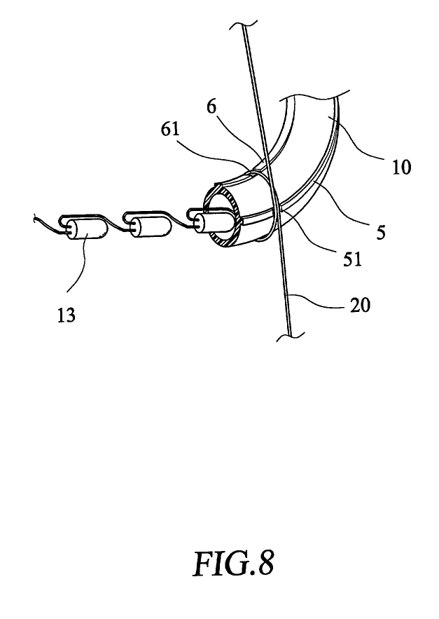

When a rope 20 passes across the elongate tube 10, the rope 20 may be wound both on the concave section 51 of the first extended rib 5 and the concave section 61 of the second extended rib 6, as shown in FIG. 8.

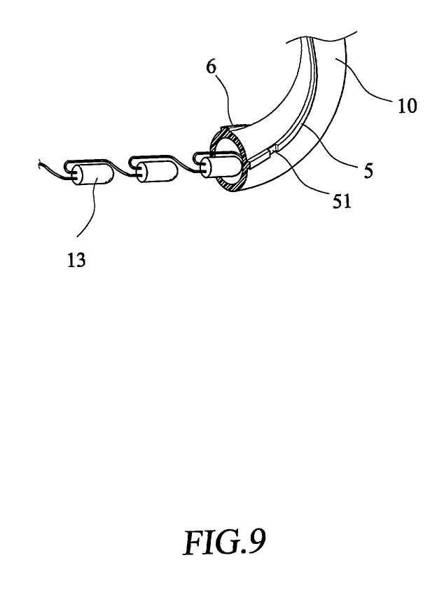

FIG. 9 is an enlarge exploded view of an elongate tube in accordance with a third embodiment of the present invention. The elongate tube of this embodiment is similar to that of the second embodiment described above, except that the first extended rib 5 and the second extended rib 6 are spirally formed along the longitudinal axis of the elongate tube 10.

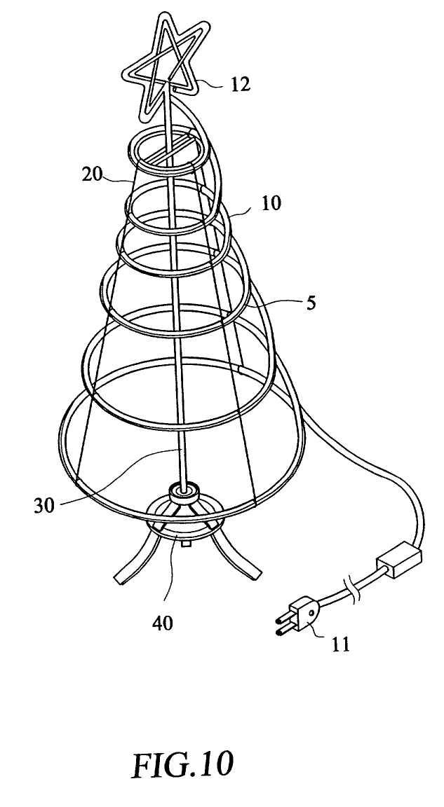

FIG. 10 is a perspective view of a spiral decorative light tree constructed in accordance with the present invention. The first end of the elongate tube 10 of the present invention is supported on the central post 30 and the free second end of which is spirally suspended around the central post 30. The ropes 20 extend at a predetermined angle with respect to the central post 30 and angularly spaced from each other about the central post 30, winding on the elongate tube 10.

The central post 30 is mounted on a stand 40 for supporting the elongate tube 10. Alternatively, the central post 30 may be formed with a tapering lower end (not shown) for facilitating piercing into the ground when the spiral decorative light tree is used outdoor.

The ropes 20 are generally made of Nylon material and suitable to be wound on the concave section of the elongate tube 10. No clipping member is required to clip the rope on the elongate tube.

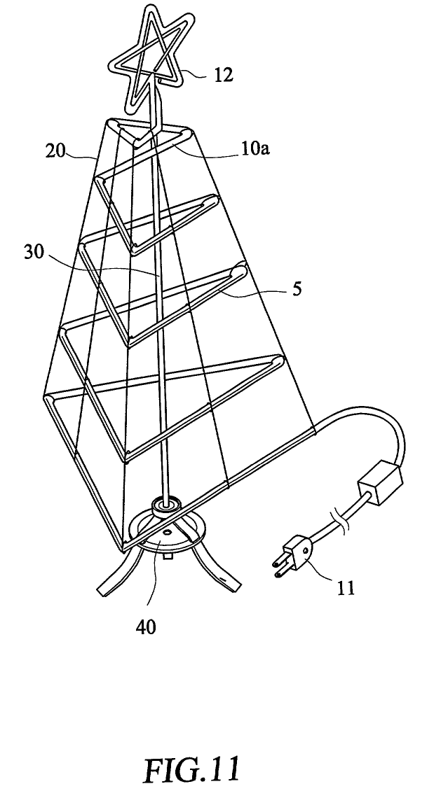

The decorative light tree may be assembled in a manner of pyramid configuration, as shown in FIG. 11. In this embodiment, the elongate tube 10a includes a number of straight sections.

Although the present invention has been described with respect to the preferred embodiments, it is contemplated that a variety of modifications, variations and substitutions may be done without departing from the scope of the present invention that is intended to be defined by the appended claims.

1. A decorative light assembly comprising:
a central post having a top end and a bottom end;
an elongate tube having a first end supported on the top end of the central post and a free second end spirally suspended around the central post;
at least one extended rib formed on the elongate tube, extended in a direction parallel to a longitudinal axis of the elongate tube; and
a plurality of ropes extending at a predetermined angle with respect to the central post and angularly spaced from each other about the central post, winding on the elongate tube thereby retaining the elongate tube in a three-dimensional spiral shape.

2. The decorative light assembly as claimed in claim 1, wherein the extended rib formed on the elongate tube is further provided with a plurality of concave sections, so that the rope passing across the elongate tube is wound on the concave section to prevent the rope from sliding along the elongate tube.

3. The decorative light assembly as claimed in claim 1, wherein the elongate tube is formed with a hollow inner tube therein.

4. The decorative light assembly as claimed in claim 3, further comprising a plurality of light units electrically connected in series and arranged inside the hollow inner tube of the elongate tube.

5. A decorative light assembly comprising:
an elongate tube having a first end and a second end, formed with a hollow inner tube therein;
a plurality of light units electrically connected in series and arranged inside the hollow inner tube of the elongate tube; and
at least one extended rib formed on the elongate tube, extended in a direction parallel to a longitudinal axis of the elongate tube.

6. The decorative light assembly as claimed in claim 5, wherein the extended rib formed on the elongate tube is further provided with a plurality of concave sections.

7. The spiral decorative light assembly as claimed in claim 5, wherein the extended rib is formed on an outer fringe surface parallel to the longitudinal axis of the elongate tube.

8. The spiral decorative light assembly as claimed in claim 5, wherein the extended rib is formed on a top fringe surface parallel to the longitudinal axis of the elongate tube.
